(19) United States
(12) Patent Application Publication
(10) Pub. No.: US 2017/0219866 A1
(43) Pub. Date: Aug. 3, 2017

(54) Liquid Crystal Display Panel

(71) Applicant: Wuhan China Star Optoelectronics Technology Co., Ltd., Wuhan (CN)

(72) Inventor: Haibo PENG, Shenzhen (CN)

(73) Assignee: Wuhan China Star Optoelectronics Technology Co., Ltd., Wuhan (CN)

(21) Appl. No.: 15/065,864

(22) Filed: Mar. 10, 2016

(30) Foreign Application Priority Data
Jan. 28, 2016 (CN) 201610059553.3

(51) Int. Cl. G02F 1/1339; G02F 1/1335; G02F 1/1368

(52) U.S. Cl. CPC G02F 1/13394; G02F 1/1368; G02F 1/133514; G02F 2001/13398; G02F 2001/13396

(57) ABSTRACT

The present disclosure discloses a liquid crystal display panel, the liquid crystal display panel includes a first substrate, a second substrate and a liquid crystal layer between the first substrate and the second substrate, the first substrate disposes a first supporting pole, the first supporting pole stretches towards the second substrate and is disposed with a gap of the second substrate, a position of a surface of the second substrate towards the first supporting pole is disposed a roughened region, the roughened region comprises at least one notch. Through the above way, the present disclosure cloud prevent the liquid crystal display panel from light leakage.

### BACKGROUND OF THE DISCLOSURE

1. Field of the Disclosure

The present disclosure relates to a liquid crystal display technical field, and in particular to liquid crystal display panel.

2. The Related Arts

The current liquid crystal display design, a main factor that must be considered is the distance from a main supporting pole to a pixel opening area, the main reason is that in the manufacturing, handling and using process of the panel, glass is easily distorted by external force, at this time, the supporting pole which is used to mainly support easily shifts and scratches the alignment film when it shores up top, once the alignment film of the pixel display region is scratched, the liquid crystal molecules lost the orientation of the alignment film, the arrangement is disordered, the light leakage problem would occur.

Therefore, designers will generally preset a minimum distance from main PS to the pixel opening area, such as 10 um, thereby it results the pixel aperture ratio is limited, especially for high PPI, Pixels Per Inch, products, because the pixel aperture ratio itself is not high, the impact of this problem will become more serious.

Therefore, a liquid crystal display is required to solve the above technical issues.

### SUMMARY OF THE DISCLOSURE

The technical issue to be mainly solved by the present disclosure is to provide a liquid crystal display panel, which can effectively prevent the light leakage problem.

In order to solve the above technical issue, a technical solution adopted by the present disclosure is to provide a liquid crystal display panel, said liquid crystal display panel comprises a first substrate, a second substrate and a liquid crystal layer between said first substrate and said second substrate, said first substrate disposing a first supporting pole, said first supporting pole stretching towards the second substrate and being disposed with a gap of said second substrate, a position of a surface of said second substrate towards said first supporting pole being disposed a roughened region, said roughened region comprising at least one notch.

Wherein said characteristic is that said liquid crystal display panel is curved surface liquid crystal display panel.

Wherein said characteristic is that a shape of said notch could be round, square, oval, diamond, circular, elliptical ring shape, block-shaped or diamond-shaped.

Wherein said characteristic is that the surface of said second substrate towards said first substrate is disposed a flattening layer, said notch being disposed on said flattening layer.

Wherein said characteristic is that at least one notch comprises a first notch and a second notch which are circular, a diameter of said first notch being less than said second notch and being concentrically disposed with said second notch.

Wherein said characteristic is that said second substrate is thin film transistor array substrate, said first substrate being a color filter substrate.

Wherein said characteristic is that a material of said first supporting pole is photoresist material.

Wherein said characteristic is that on said first substrate also provides a second supporting pole, a height of said second supporting pole being less than said first supporting pole.

Wherein said characteristic is that the direction of the outer contour diameter of said first supporting pole and said second supporting pole near said first substrate progressively increases.

Wherein said characteristic is that the material of said second supporting pole is photoresist material.

The benefit effect of the present disclosure is to distinguish the situation of the prior art, the present disclosure through a position of a surface of said second substrate towards said first supporting pole being disposed a roughened region, said roughened region comprising at least one notch, the friction of the surface of the first supporting pole and the second supporting pole cloud increase, thereby the moving distance of the first supporting pole is limited in order to prevent the alignment film from being scratched, effectively preventing the light leakage issue of the liquid crystal display panel.

### BRIEF DESCRIPTION OF THE DRAWINGS

FIG. 1 is a structure schematic diagram of a liquid crystal display panel of the present disclosure;

FIG. 2 is a top view schematic diagram of a second substrate in FIG. 1;

FIG. 3 is a top view schematic diagram of the other embodiment of a second substrate.

### DETAILED DESCRIPTION OF THE PREFERRED EMBODIMENTS

Following combines the drawings and embodiments to describe the present disclosure in detail.

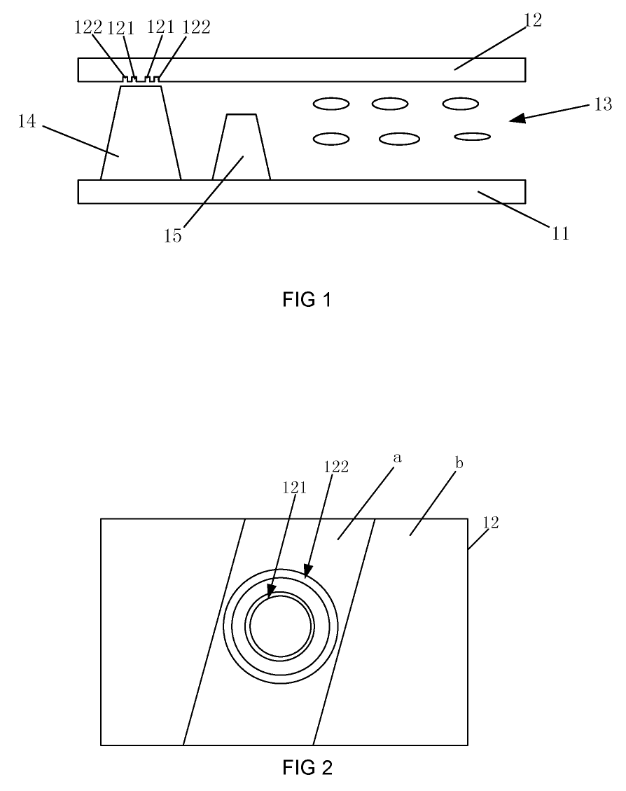

Refer to FIG. 1, FIG. 1 is a structure schematic diagram of a liquid crystal display panel of the present disclosure. In the present embodiment, the liquid crystal display panel includes a first substrate 11, a second substrate 12 and a liquid crystal layer 13 between the first substrate 11 and a second substrate 12, on the first substrate 11 is disposed a first supporting pole 14, the first supporting pole 14 stretches towards the second substrate 12 and is disposed with a gap of said second substrate 12, a position of a surface of the second substrate 12 towards the first supporting pole 11 and faces the supporting pole 14 is disposed a roughened region, the roughened region comprises at least one notch.

Preferably, in the present embodiment, the liquid crystal display panel is curved surface liquid crystal display panel, the figure is only schematic, in actually, the first substrate 11 and the second substrate is bendable.

Combine FIG. 1 and further refer to FIG. 2, FIG. 2 is a top view schematic diagram of a second substrate in FIG. 1. Preferably, in the present embodiment, at least one notch includes a first notch 121 and a second notch 122 which are circular, a diameter of the first notch 121 is less than the second notch 122 and is concentrically disposed with the second notch 122.

Preferably, the second substrate 12 is a thin film transistor array substrate 12, the first substrate 11 is a color filter substrate 11.

Preferably, the surface of the second substrate 12 towards the first substrate 11 is disposed a flattening layer (unmarked), the notch is disposed on the flattening layer, for example, the corresponding position of the flattening layer is etched to form the notch. For example, the liquid crystal display panel is FFS, Fringe Field Switching, panel, the outermost layer that the thin film transistor array substrate 12 adjacent to the first substrate 11 is PLN flattening layer. Carry on the grooving process on the position where the PLN flattening layer of the thin film transistor array substrate 12 faces the first supporting pole 14, the surface of the area that the first supporting pole 14 corresponds to the thin film transistor array substrate 12 becomes uneven through grooving, when the panel is twisted (including that curved surface liquid crystal display panel manufacturing process needs to be twisted or an unexpected twist during transport), the difficulty of displacement of the first supporting pole 14 increases, the displacement distance significantly reduces, this design can reduce the distance from the area A opposite the first supporting pole 14 to the pixel opening area B, such as reducing from 5 um to 10 um, thereby achieving the purpose of increasing aperture ratio, the effect of increasing the area of pixel opening area B is more significant on high PPI products, at the same time, the ability that the panel resists the external force also cloud improve, the alignment film will not be scratched by twisting nor does the light leakage generate, even if the distortion occurs, it will not affect the display quality, more significantly increasing the production yields.

Preferably, the material of the first supporting pole 14 is photoresist material.

Preferably, on the first substrate 11 also provides a second supporting pole 15, a height of said second supporting pole 15 is less than the first supporting pole 14.

Preferably, the direction of the outer contour diameter of the first supporting pole 11 and the second supporting pole 15 near the first substrate 14 progressively increases.

Preferably, the material of the second supporting pole is also photoresist material.

Preferably, as shown in figures, the first supporting pole 14, Main PS, which is higher plays a major supportive role, the second supporting pole 15, Sub PS, which is lower plays a secondary supportive role.

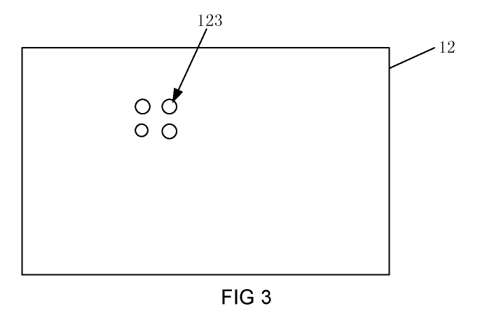

In the other embodiments, the shape of said notch could be round, square, oval, diamond, circular, elliptical ring shape, block-shaped or diamond-shaped, or a combination of any two or more kinds of shapes. For example, refer to FIG. 3, FIG. 3 is a top view schematic diagram of the other embodiment of a second substrate. In the embodiment, the notch shape is round. Need to be considered is that the above shapes are cross-sectional shape which the notch along with the direction of paralleling with the second substrate 12, and the shape of the notch is not limited by above description.

The preferred embodiments according to the present disclosure are mentioned above, which cannot be used to define the scope of the right of the present disclosure.

Those variations of equivalent structure or equivalent process according to the present specification and the drawings or directly or indirectly applied in other areas of technology are considered encompassed in the scope of protection defined by the claims of the present disclosure.

What is claimed is:

1. A liquid crystal display, wherein said characteristic is that said liquid crystal display panel comprises a first substrate, a second substrate and a liquid crystal layer between said first substrate and said second substrate, said first substrate disposing a first supporting pole, said first supporting pole stretching towards the second substrate and being disposed with a gap of said second substrate, a position of a surface of said second substrate towards said first supporting pole being disposed a roughened region, said roughened region comprising at least one notch.

2. The liquid crystal display panel as claimed in claim 1, wherein said characteristic is that said liquid crystal display panel is curved surface liquid crystal display panel.

3. The liquid crystal display panel as claimed in claim 1, wherein said characteristic is that a shape of said notch could be round, square, oval, diamond, circular, elliptical ring shape, block-shaped or diamond-shaped.

4. The liquid crystal display panel as claimed in claim 1, wherein said characteristic is that the surface of said second substrate towards said first substrate is disposed a flattening layer, said notch being disposed on said flattening layer.

5. The liquid crystal display panel as claimed in claim 1, wherein said characteristic is that at least one notch comprises a first notch and a second notch which are circular, a diameter of said first notch being less than said second notch and being concentrically disposed with said second notch.

6. The liquid crystal display panel as claimed in claim 1, wherein said characteristic is that said second substrate is thin film transistor array substrate, said first substrate being a color filter substrate.

7. The liquid crystal display panel as claimed in claim 1, wherein said characteristic is that a material of said first supporting pole is photoresist material.

8. The liquid crystal display panel as claimed in claim 1, wherein said characteristic is that on said first substrate also provides a second supporting pole, a height of said second supporting pole being less than said first supporting pole.

9. The liquid crystal display panel as claimed in claim 8, wherein said characteristic is that the direction of the outer contour diameter of said first supporting pole and said second supporting pole near said first substrate progressively increases.

10. The liquid crystal display panel as claimed in claim 9, wherein said characteristic is that the material of said second supporting pole is photoresist material.
